(19) United States
(12) Patent Application Publication
(10) Pub. No.: US 2014/0136467 A1
(43) Pub. Date: May 15, 2014

(54) METHODS AND MATERIALS FOR PROVIDING A PROGNOSTIC SCORING SYSTEM FOR THE DEVELOPMENT OF PROSTHETIC JOINT INFECTION

(71) Applicants: Elie F. Berbari, Rochester, MN (US); Douglas R. Osmon, Rochester, MN (US)

(72) Inventors: Elie F. Berbari, Rochester, MN (US); Douglas R. Osmon, Rochester, MN (US)

(73) Assignee: MAYO FOUNDATION FOR MEDICAL EDUCATION AND RESEARCH, Rochester, MN (US)

(21) Appl. No.: 14/129,711

(22) PCT Filed: Jun. 29, 2012
(86) PCT No.: PCT/US2012/044935

§ 371 Date: Jan. 31, 2014

Related U.S. Application Data
(60) Provisional application No. 61/502,662, filed on Jun. 29, 2011.

(51) Int. Cl. G06N 5/04

(52) U.S. Cl. CPC G06N 5/048
USPC 706/52

(57) ABSTRACT

This document provides methods and materials for providing a scoring system to prognose the development of prosthetic joint infection (PJI). For example, a prognostic scoring system as well as methods for making and using a prognostic scoring system for the development of PJI to assist clinicians in implementing intervention or early diagnostic strategies are provided.

### CROSS-REFERENCE TO RELATED APPLICATIONS

This application claims the benefit of U.S. Provisional Application Ser. No. 61/502,662, filed Jun. 29, 2011. The disclosure of the prior application is considered part of (and is incorporated by reference in) the disclosure of this application.

### BACKGROUND

1. Technical Field

This document relates to methods and materials involved in providing a prognostic scoring system for the development of prosthetic joint infection (PJI). For example, this document relates to a prognostic scoring system and methods for making and using a prognostic scoring system for the development of PJI to assist clinicians in implementing intervention or early diagnostic strategies.

2. Background Information

Due to the aging US population, it is estimated that by 2030, approximately 4 million total hip arthroplasties (THA) or total knee arthroplasties (TKA) will be performed annually in the US. Although the overall outcome of THA or TKA is excellent, PJI is a rare (<2%) but well-recognized complication that causes significant morbidity and mortality. After PJI is diagnosed, antimicrobial therapy alone is rarely effective. Most patients require reoperation and eventually removal of the joint components in order to eradicate the infection.

### SUMMARY

This document provides methods and materials for providing a scoring system to prognose the development of PJI. For example, this document provides a prognostic scoring system as well as methods for making and using a prognostic scoring system for the development of PJI to assist clinicians in implementing intervention or early diagnostic strategies. As described herein, scores that predict the risk of PJI in patients undergoing THA or TKA can be measured at the time of surgery (the baseline risk score) and one month post-surgery (the post-surgery risk score). Both the baseline risk score and the post-surgery risk score can be calculated from the following independent variables: body mass index (BMI) ≧40 or <25, prior other surgery on the index joint, prior arthroplasty, immunosuppression, American Society of Anesthesiologists (ASA) score of 3 or 4, and procedure duration lasting <2 hours or >4 hours. In addition, the post-surgery risk score includes post-operative wound drainage. An individual patient score is computed by adding various points assigned to each risk factor. This prognostic scoring system for the development of PJI can allow clinicians to treat patients successfully at an early stage or prevent the development of PJI all together. This can save patients from reoperation, loss of joint prosthesis, limb amputation, and even death.

Unless otherwise defined, all technical and scientific terms used herein have the same meaning as commonly understood by one of ordinary skill in the art to which this invention pertains. Although methods and materials similar or equivalent to those described herein can be used in the practice or testing of the present invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

Other features and advantages of the invention will be apparent from the following detailed description, and from the claims.

### DESCRIPTION OF DRAWINGS

FIG. 1 contains ROC curves from final models for the baseline risk score (A) and the post-surgery risk score (B).

FIG. 2 contains predicted probability plots from final models for the baseline risk scores (A) and the post-surgery risk scores (B).

### DETAILED DESCRIPTION

This document provides methods and materials for providing a scoring system to prognose the development of PJI. For example, this document provides a prognostic scoring system as well as methods for making and using a prognostic scoring system for the development of PJI to assist clinicians in implementing intervention or early diagnostic strategies. As described herein, two scores can be measured, a baseline risk score and a post-surgery risk score, to predict the risk of PJI in patients undergoing THA or TKA. In some cases, the baseline risk score can be measured at the time of surgery, and the post-surgery risk score can be measured one month after surgery. In some cases, the baseline risk score can be measured on the day of surgery or at any point from about four weeks before surgery to the day of surgery (e.g., one, two, three, or four weeks before surgery). In some cases, post-surgery risk score can be measured at any point from about two weeks after surgery to about eight weeks after surgery (e.g., two, three, four, five, six, seven, or eight weeks after surgery).

For both the baseline risk score and post-surgery risk score, a BMI ≧40 or <25 kg/m², immunosuppression state, prior arthroplasty, prior other surgery, an ASA score of 3 or 4, and a procedure duration ≦2 hours or >4 hours all contributed to an increased risk of subsequent PJI. In some cases, the post-surgery risk score can also include post operative wound drainage. The risk of PJI for patients increases with the number of points accrued in the score.

The BMI variable of a prognostic scoring system for the development of PJI provided herein can be measured using any appropriate method. For example, BMI can be calculated by measuring a patient's height and weight. BMI can equal a patient's weight in pounds divided by the square of their height in square inches, multiplied by 703. In some cases, BMI can equal a patient's weight in kilograms divided by the square of their height in meters. A BMI ≧40 or <25 kg/m² can be assigned a score of 2 in the baseline risk score and a score of 1 in the post-surgery risk score (Table 1). A BMI ≧40 can indicate morbid obesity, which can have many associated co-morbid conditions. Multiple mechanisms may explain the increased risk of PJI in patients with low BMI. Patients with low BMI might have less nutritional reserve, resulting in greater risk for surgical site infection (SSI) (Jensen et al. (1982, JBJS). In some cases, a low BMI can be more common in the elderly and in patients with significant comorbidities such as immunosuppression, rheumatoid arthritis or nicotine dependency. These confounding factors can be associated with an increased risk of PJI.

TABLE I
Final models and scoring for baseline and post-surgery risk scores

| | Baseline Risk Score | | 1 month Risk Score | |
|---|---|---|---|---|
| | Final Multivariable | | Final Multivariable | Points for Risk |
| Risk Factor | Model Results | Points for Risk Score | Model Results | Score |
| BMI: | | | | |
| <25 or ≧40 | 2.01 (1.39, 2.93) [<.001] | 2 | 1.98 (1.34, 2.94) [<.001] | 1 |
| 25-40 | 1.0 (ref) | 0 | 1.0 (ref) | 0 |
| Prior other operation | 1.72 (1.18, 2.50) [0.005] | 2 | 1.63 (1.10, 2.42) [0.015] | 1 |
| Prior arthroplasty | 2.12 (1.38, 3.27) [<.001] | 2 | 1.98 (1.26, 3.12) [0.003] | 1 |
| Immunosuppression | 1.97 (1.40, 2.78) [<.001] | 2 | 1.92 (1.34, 2.74) [<.001] | 1 |
| ASA score: | | | | |
| 1-2 | 1.0 (ref) [F test p <.001] | 0 | 1.0 (ref) [F test p 0.009] | 0 |
| 3 | 1.84 (1.29, 2.63) [<.001] | 2 | 1.61 (1.10, 2.34) [0.013] | 1 |
| 4 | 7.19 (1.51, 34.16) [0.013] | 6 | 5.35 (1.02, 27.88) [0.047] | 3 |
| Procedure time: | | | | |
| <2 hours | 1.57 (1.09, 2.26) [0.014] | 1 | 1.66 (1.14, 2.42) [0.008] | 1 |
| 2-4 hours | 1.0 (ref) [F test p 0.006] | 0 | 1.0 (ref) [F test p 0.003] | 0 |
| >4 hours | 2.35 (1.22, 4.53) [0.011] | 3 | 2.57 (1.31, 5.07) [0.006] | 2 |
| Wound drainage w/in 1 month | — | — | 4.76 (1.66, 13.66) [0.004] | 3 |
| | c-statistic, 0.720 | range, 0-13 | c-statistic, 0.716 | range, 0-9 |

The immunosuppression variable of a prognostic scoring system for the development of PJI provided herein can be determined in any appropriate manner. For example, by examining the patient's medical record, it can be determined if the patient is taking medication that causes immunosuppression, undergoing radiation-induced immunosuppressive therapy, diagnosed with HIV or AIDS or diagnosed with an autoimmune disorder. Immunosuppression can be assigned a score of 2 in the baseline risk score and a score of 1 in the post-surgery risk score (Table 1).

A patient history of prior arthroplasty and prior other surgeries can increase the risk of developing PJI. Prior arthroplasty can include prior joint replacements anywhere in the body. Prior other surgeries can include any surgery other than prosthetic joint replacement. Prior arthroplasty and prior other surgeries can each be assigned a score of 2 in the baseline risk score and a score of 1 in the post-surgery risk score (Table 1).

The ASA score variable of a prognostic scoring system for the development of IPJ provided herein can be determined prior to surgery. The ASA score can be a global score that assesses the physical status of patients before surgery. An ASA score of 1 indicates a normal, healthy patient. An ASA score of 2 can be associated with a patient with mild systemic disease. An ASA score of 3 can be assigned to a patient with severe systemic disease. An ASA score of 4 can indicate a patient with severe systemic disease that is a constant threat to the patient's life, and a score of 5 can indicate a moribund patient who is not expected to survive. An ASA score of 3 can be assigned a score of 2 in the baseline risk score and a score of 1 in the post-surgery score. An ASA score of 4 can be assigned a score of 6 in the baseline risk score and a score of 3 in the post-surgery score.

A prosthetic joint replacement procedure duration ≦2 hours or >4 hours can contribute to PJI risk. Procedure duration >4 hours can be assigned a score of 3 in the baseline risk score and a score of 2 in the post-surgery risk score (Table 1). A procedure time of more than 4 hours exposes the patient for a longer period of time in a potentially infective environment. A procedure duration ≦2 hours can be assigned a score of 1 in both the baseline risk score and post-surgery risk score (Table 1). The reasons for this association may be related to surgical techniques such as aggressive use of cautery resulting in significant inviable tissue or a false sense of security leading to a low compliance with other aseptic techniques and infection control measures during surgeries.

The post-surgery risk score takes into account the possibility of development of wound healing complications following surgery as an additional risk factor. This score can be used in the postoperative period as an early trigger for PJI workup in patients with early signs or symptoms suggestive of PJI. Patients with persistent joint pain, ongoing wound drainage for more than one week or early periprosthetic loosening and a high post-surgery risk score should be assessed for the need of aspiration of periprosthetic fluid, and early intervention such as debridement and retention of the prosthesis.

The scoring system to prognose the development of PJI can be used in several ways. In high risk patients undergoing THA or TKA, selected preoperative interventions could minimize the risk of PJI with respect to BMI (goal 25-40 kg/m²), immunosuppression (glycemic control, medication management), and identification and treatment of preoperative anemia (minimize transfusion-related immunosuppression). This baseline risk score further emphasizes the importance of efficient surgery (surgical time). In addition, selected patients identified as high risk may benefit from individualized interventions such as the use of antimicrobial fixation cement, nasal S. aureus colonization screening and decolonization and the use of vancomycin-tethered titanium prostheses.

Another use of the baseline risk score can be related to risk stratification and reporting. The currently used NHSN surgical risk stratification for reporting of surgical site infection in patients undergoing THA or TKA relies solely on ASA and operative time since all surgeries in this category are considered a type I surgery. This score would allow better risk stratification since equally important predictors such as

BMI, prior arthroplasty, underlying immunosuppression, or prior surgery on the index joint are all taken into account. These additional factors taken into account in public reporting of SSI rates in THA or TKA, enable the CDC to compare and contrast SSI rates among various institutions. This would be more relevant in the future as implementation of the Affordable Care Act will require payment to hospitals be adjusted for health care acquired complications (HACs) including SSI. This model could assure tertiary referral institutions and specialty orthopedic institutions, involved in the care of high risk patients, the ability to perform surgeries on high risk patients without the fear of being penalized for their “relatively higher SSI rate”. The invention will be further described in the following examples, which do not limit the scope of the invention described in the claims.

### EXAMPLES

### Example 1

### Prognostic Scoring System for the Development of Prosthetic Joint Infection

### Patients and Methods

A previously published large, single-center, prospective case-control study was conducted and examined the risk of prosthetic hip or knee infection associated with dental procedures (Berbari et al., Clin. Infect. Dis., 50:8-16 (2010)). Surveillance for case patients and control subjects at the Mayo Clinic was conducted.

Case patients were patients with a diagnosis of prosthetic hip or knee infection (Table 2) who were hospitalized at the Mayo Clinic during the study period. Control subjects were patients who were hospitalized on an orthopedic service during the same time period for a non PJI etiology. Paired matching was not preformed on any variable. Frequency matching was used between case patients and control subjects on the location of joint arthroplasty. Structured forms were used to interview patients and abstract medical records data. Patients enrolled in this study served as the training data set for developing the score (Berbari et al., Clin. Infect. Dis., 50:8-16 (2010)).

TABLE 2
Definition of PJI and candidate variables in the prognostic scoring
system for the development of PJI

Prosthetic hip or knee infection
Isolation of the same microorganism from 2 cultures from joint or periprosthetic fluid
specimens or the presence of acute inflammation consistent with infection on
histopathological examination (as determined by the pathologist) or the presence
cutaneous sinus tract communicating with the prosthesis, or the presence of purulence
in a joint space (as determined by the surgeon)
Preoperative Factors
Body mass index (BMI): Calculated by a ratio of height and weight By using
measurements that are the closet to surgery
Diabetes mellitus: Based on the ADA criteria
Prior operation on the index joint: any prior surgery performed on the joint where the
capsule was opened (i.e. Arthrotomy, osteotomy, arthroscopy, etc.)
Prior arthroplasty on the index joint: Any arthroplasty performed prior to the index
surgery
Immunosuppression: The presence of any of the following conditions: rheumatoid
arthritis, current use of systemic corticosteroids/immunosuppressive drugs, diabetes
mellitus, presence of a malignancy, and a history of chronic kidney disease.
Rheumatoid arthritis: As diagnosed by the attending physician and documented in the
records
Malignancy: Any prior history of systemic malignancy as documented in the medical
records
Operative factors
American Society of Anesthesia score (ASA): As recorded in the Anesthesia records
at the time of THA or TKA.
Antibiotic surgical prophylaxis: A dose of antibiotic delivered within 120 minutes of
the incision for a TKA or THA
Procedure time: Time elapsed between surgical incision and wound closure
Post operative factors
Post arthroplasty wound drainage: As diagnosed by the attending physician and
documented in the records
Post arthroplasty wound dehiscence: As diagnosed by the attending physician and
documented in the records
Post arthroplasty wound hematoma: As diagnosed by the attending physician and
documented in the records
Post arthroplasty SSI: Wound infection as defined per the Centers for Disease Control
and Prevention
Distant organ infection: Urinary tract infection, respiratory tract infection, cellulitis,
other organ infection

### Development of PJI Prediction Score

Two scores were constructed: the baseline risk score and the post-surgery risk score. The baseline risk score excluded post-operative variables such as post-operative wound healing complications (drainage, hematoma, dehiscence, superficial SSI, and distant organ infection) and included only variables that were available in the pre or operative period. The post-surgery risk score was constructed to include preoperative, operative and post-operative variables occurring within 1 month of implant surgery (Table 2).

In order to develop each score, the risk factors previously detected from univariate analysis (Table 3) (Berbari et al., Clin. Infect. Dis., 50:8-16 (2010)) were identified. Patients with missing data were excluded from the analysis of each variable. All factors included in Table 3 had a significant association with PJI. Subsequently, multivariable modeling was performed in order to determine which of the univariate-associated variables were independent risk factors for PJI. Factors that were univariately-associated with PJI were candidates for the multivariable analysis. High correlation between each pair of covariates was checked so as to prevent collinearity in the modeling. For this reason, hematoma was excluded due to high correlation with other wound healing complications, and dehiscence for the same reason and also because of very low exposure prevalence.

TABLE 3
Risk factors for PJI used in developing the baseline risk score

| | Cases | Controls | Univariate | Stepwise Selected | Frequency Retained |
|---|---|---|---|---|---|
| Variable | (n = 301) | (n = 316) | Results | Model Results | from Bootstrap |
| Female gender | 150 (50%) | 167 (53%) | 0.89 (0.65, 1.22) [0.454] | not considered | — |
| BMI: | | | | | |
| <25 | 68 (23%) | 48 (15%) | 1.0 (ref) [F test p <.001] | 1.0 (ref) [F test p 0.003] | 94.5% |
| 25-30 | 85 (28%) | 113 (36%) | 0.53 (0.33, 0.84) [0.008] | 0.52 (0.31, 0.85) [0.010] | 85.1% |
| 31-39 | 94 (31%) | 129 (41%) | 0.51 (0.33, 0.81) [0.004] | 0.49 (0.30, 0.81) [0.005] | 88.4% |
| 40+ | 54 (18%) | 26 (8%) | 1.47 (0.81, 2.66) [0.209] | 1.05 (0.55, 2.03) [0.876] | 12.2% |
| Diabetes | 59 (20%) | 38 (12%) | 1.78 (1.15, 2.78) [0.010] | not selected | 17.7% |
| Prior other operation | 107 (36%) | 76 (24%) | 1.74 (1.23, 2.47) [0.002] | 1.70 (1.17, 2.49) [0.006] | 83.5% |
| Prior arthroplasty | 93 (31%) | 51 (16%) | 2.32 (1.58, 3.42) [<.001] | 2.09 (1.36, 3.22) [<.001] | 93.4% |
| Immunosuppression | 183 (61%) | 137 (43%) | 2.03 (1.47, 2.79) [<.001] | 1.98 (1.40, 2.80) [<.001] | 95.0% |
| ASA score: | | | | | |
| 1 | 15 (5%) | 23 (7%) | 1.0 (ref) [F test p <.001] | 1.0 (ref) [F test p 0.001] | 93.1% |
| 2 | 139 (46%) | 198 (63%) | 1.08 (0.54, 2.14) [0.833] | 1.27 (0.61, 2.66) [0.527] | 17.3% |
| 3 | 137 (46%) | 93 (29%) | 2.26 (1.12, 4.56) [0.023] | 2.26 (1.05, 4.86) [0.036] | 67.1% |
| 4 | 10 (3%) | 2 (1%) | 7.67 (1.47, 39.98) [0.016] | 8.92 (1.62, 48.99) [0.012] | 70.9% |
| Antibiotic surgical | 243 (81%) | 273 (86%) | 0.66 (0.43, 1.02) [0.059] | not selected | 21.3% |
| prophylaxis | | | | | |
| Procedure time: | | | | | |
| <2 | 134 (45%) | 135 (43%) | 1.0 (ref) [F test p <.001] | 1.0 (ref) [F test p 0.013] | 84.3% |
| 2-3 | 85 (28%) | 121 (38%) | 0.71 (0.49, 1.02) [0.064] | 0.60 (0.41, 0.90) [0.012] | 72.7% |
| 3-4 | 38 (13%) | 43 (14%) | 0.89 (0.54, 1.46) [0.647] | 0.72 (0.42, 1.24) [0.236] | 30.4% |
| 4+ | 44 (15%) | 17 (5%) | 2.61 (1.42, 4.79) [0.002] | 1.52 (0.78, 2.98) [0.222] | 36.7% |

* based on all 617 cases and controls at baseline with complete data

To develop a multivariable model consisting only of independent risk factors of PJI, automated stepwise selection and bootstrap techniques were heavily relied on. The bootstrap is a re-sampling method often used to estimate a statistic by approximating its distribution from numerous iterative resamples of the observed data. At each iteration, a distinct bootstrap sample of equal size to the observed sample is drawn using random sampling with replacement. The statistic is then estimated from the distribution of bootstrapped data. This technique was also used in regression analysis to evaluate the stability of a model or the prognostic consistency of a particular covariate. Bootstrap re-sampling with 1000 iterations was used to guide the model selection process. The frequency of each variable retained in the model using the pre-specified model selection criteria (stepwise and backward selection, entry p<0.10 and retention p<0.05) was computed as a percentage of all 1000 bootstrap samples. The modeling strategy required that the factors incorporated into the final score model each be retained in at least 80% of the bootstrap samples, thus reducing the chance of type 1 error. All pair-wise interactions were also considered for inclusion in the model selection.

### Results

Using 1000 bootstrap samples, pair-wise interactions among the factors in Table 3 were first evaluated to determine if any were consistently retained in selected models. From both stepwise and backward selection, no interactions were retained in the selected model at least 80% of the time. As a result, all subsequent bootstrapping was performed assuming an additive model.

From the next round of bootstrapping without interactions, the additive effect of hypothesized risk factors in multivariable modeling was assessed (Table 4). The following variables were retained from stepwise selection in at least 80% of bootstrap samples and deemed as independent prognostic factors of PJI in both scores: BMI≧40 or <25, prior other operation on the index joint, prior arthroplasty, immunosuppression, ASA score of 3 or 4 and procedure duration <2 hours or >4 hours. The post-surgery risk score contained the same variables as the baseline risk score in addition to post-operative wound drainage. Factors not associated with PJI after adjusting for other risk factors included urinary tract infection and antibiotic surgical prophylaxis. For the six factors that contributed to the baseline risk score and the seven that contributed to the post-surgery risk score, an independent association was demonstrated and each was carefully examined to ensure their association with PJI made clinical sense in the context of a prognostic score.

TABLE 4
Risk factors for PJI used in developing the post-surgery risk score

| | Cases | Controls | 1-Mo. Univariate | Stepwise Selected | Frequency Retained |
|---|---|---|---|---|---|
| Variable | (n = 258) | (n = 316) | Model Results* | Model Results | from Bootstrap |
| Female gender | 126 (49%) | 167 (53%) | 0.85 (0.61, 1.18) [0.339] | not considered | — |
| BMI: | | | | | |
| <25 | 58 (22%) | 48 (15%) | 1.0 (ref) [F test p <.001] | 1.0 (ref) [F test p 0.006] | 90.5% |
| 25-30 | 78 (30%) | 113 (36%) | 0.57 (0.35, 0.92) [0.022] | 0.55 (0.33, 0.92) [0.023] | 72.8% |
| 31-39 | 79 (31%) | 129 (41%) | 0.51 (0.32, 0.81) [0.005] | 0.46 (0.27, 0.77) [0.003] | 86.6% |
| 40+ | 43 (17%) | 26 (8%) | 1.37 (0.74, 2.54) [0.320] | 0.99 (0.50, 1.97) [0.974] | 13.1% |
| Diabetes | 52 (20%) | 38 (12%) | 1.85 (1.17, 2.91) [0.008] | not selected | 22.1% |
| Prior other operation | 89 (34%) | 76 (24%) | 1.66 (1.16, 2.39) [0.006] | 1.60 (1.08, 2.38) [0.019] | 72.2% |
| Prior arthroplasty | 76 (29%) | 51 (16%) | 2.17 (1.45, 3.24) [<.001] | 1.94 (1.23, 3.06) [0.004] | 85.3% |
| Immunosupression | 159 (62%) | 137 (43%) | 2.10 (1.50, 2.93) [<.001] | 1.96 (1.37, 2.82) [<.001] | 95.0% |
| ASA score: | | | | | |
| 1 | 14 (5%) | 23 (7%) | 1.0 (ref) [F test p <.001] | 1.0 (ref) [F test p 0.026] | 76.4% |
| 2 | 123 (48%) | 198 (63%) | 1.02 (0.51, 2.06) [0.955] | 1.29 (0.60, 2.76) [0.517] | 15.4% |
| 3 | 115 (45%) | 93 (29%) | 2.03 (0.99, 4.17) [0.053] | 2.01 (0.91, 4.45) [0.083] | 50.1% |
| 4 | 6 (2%) | 2 (1%) | 4.93 (0.87, 27.88) [0.071] | 6.50 (1.07, 39.41) [0.042] | 50.8% |
| Antibiotic surgical | 210 (81%) | 273 (86%) | 0.69 (0.44, 1.08) [0.104] | not selected | 14.5% |
| prophylaxis | | | | | |
| UTI | 11 (4%) | 6 (2%) | 2.30 (0.84, 6.31) [0.105] | not selected | 39.9% |
| Procedure time: | | | | | |
| <2 | 118 (46%) | 135 (43%) | 1.0 (ref) [F test p <.001] | 1.0 (ref) [F test p 0.006] | 72.2% |
| 2-3 | 69 (27%) | 121 (38%) | 0.65 (0.44, 0.96) [0.030] | 0.56 (0.37, 0.85) [0.006] | 81.3% |
| 3-4 | 34 (13%) | 43 (14%) | 0.90 (0.54, 1.51) [0.702] | 0.71 (0.41, 1.25) [0.238] | 30.5% |
| 4+ | 37 (14%) | 17 (5%) | 2.49 (1.33, 4.65) [0.004] | 1.58 (0.79, 3.15) [0.198] | 34.0% |
| Wound drainage w/in 1 mo. | 17 (7%) | 5 (2%) | 4.39 (1.60, 12.06) [0.004] | 4.88 (1.69, 14.10) [0.003] | 91.9% |
| Deep organ infection | 3 (1%) | 2 (1%) | 1.85 (0.31, 11.14) [0.503] | not selected | 4.3% |
| w/in 1 mo. | | | | | |
| Dehiscence w/in 1 mo. | 3 (1%) | 3 (1%) | 1.23 (0.25, 6.14) [0.802] | not considered | — |
| Hematoma w/in 1 mo. | 4 (2%) | 4 (1%) | 1.23 (0.30, 4.97) [0.771] | not considered | — |

* based on 574 cases and controls with at least 30 days of follow-up (in particular, 43 cases with PJI within 30 days of implant were removed)

### Covariate Decisions

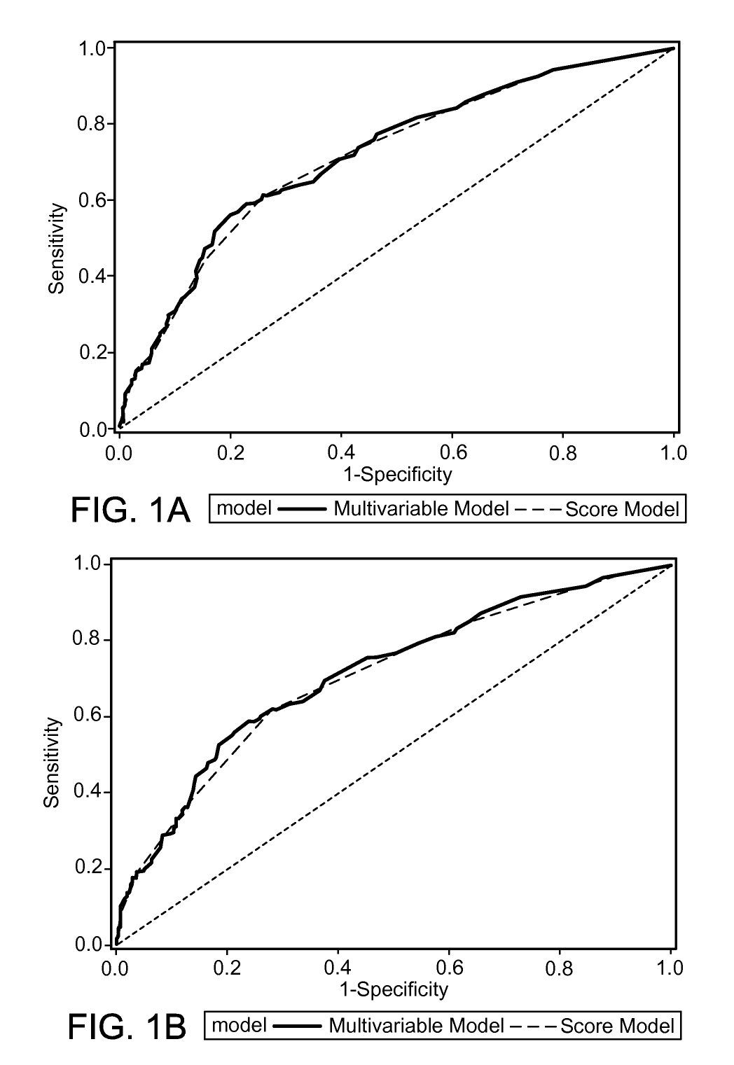

Each of the prognostic factors detected was examined to ensure its association with PJI was clinically relevant and appropriately formatted for translation into both scores. In this analysis, patients with missing values were excluded. While it might be beneficial to include all subjects in the analysis so as to optimize power and minimize the chance of a selection bias, it is difficult to think how a missing value for procedure time could possibly translate into a risk score. Of the original 339 matched cases and controls, 38 cases and 23 controls were excluded due to missing data for ASA, antimicrobial prophylaxis and operative time. Table 3 summarizes the descriptive statistics for the remaining 617 cases and controls, as well as the univariate modeling and multivariable modeling (final selected model via stepwise; entry criteria p<0.15, retain criteria p<0.10) results and the bootstrap frequencies assessing the stability of our selected model (1000 iterations; stepwise selection using same criteria above). Six risk factors were found to be independently associated with PJI in the baseline risk score. Since each risk factor was also selected in more than 70% of the bootstrap models, all were thus incorporated into the baseline risk score. Few alterations were made to the categorizations of selected variables for ease of assigning points (e.g., BMI was dichotomized into collapsed extremes of either <25 or >40 vs 25<BMI<40). The final form of these variables, along with the final modeling results are shown in Table 1, as well as the point assignment for scoring the risk tool. Also tabulated is the final model c-statistic of 0.720, and the ROC curve in FIG. 1.

For the post-surgery risk score, dates corresponding to each of the four post-op complications were obtained and only included are those that occurred within 1 month from date of implant. In addition to those subjects excluded in the baseline risk score, all cases who developed their PJI, or controls who were censored (i.e., lost to follow-up), within 1 month of implant were excluded from the analysis. This resulted in the exclusion of 43 case patients. For the post-surgery risk score a total of 574 patients were included in the analysis. Despite the additional exclusions, and the addition of post-op variables, the results from this analysis mostly mirrored those seen in the baseline risk score analysis. Table 4 summarizes the associations, which included the same six baseline risk factors and also the wound drainage variable. These seven factors were incorporated into the post-surgery risk score, using a slightly different scoring system. The relative weighting of points was almost identical to the baseline risk score as summarized in Table 1. In addition, the final model c-statistic of the post-surgery risk score was 0.716. The corresponding ROC curve is shown in FIG. 1. Even though this model contains one extra risk factor than the baseline risk score, the slightly lower c-statistic is probably attributable to the decrease in sample size by 43 cases.

### Calculating the Risk Score

Based on the final multivariable model for each score, the two risk scores were derived as a function of the important prognostic factors weighted by their relative contribution to the regression. Points were assigned for the presence of each factor based approximately on the regression coefficients: each estimate was scaled by the minimum coefficient value, and then rounded to the nearest integer. A subject's risk score is simply the cumulative number of points from their risk factor profile (Table 1).

### ROC Curve

The probability of concordance, c index, was used to quantify the predictive ability of the final multivariable logistic model. The c index is identical to the area under a receiver operating characteristic (ROC) curve, with a value of 0.5 denoting random predictions and a value of 1.0 denoting perfect predictions. Using the bootstrap-confirmed covariates, the final multivariable model was fit on the observed data and plotted the ROC curve for each risk score. Likewise, the c-statistic for the univariate score model was determined and overlaid with the plot of the ROC curve produced by the score model (FIG. 1).

### Predicted Probabilities

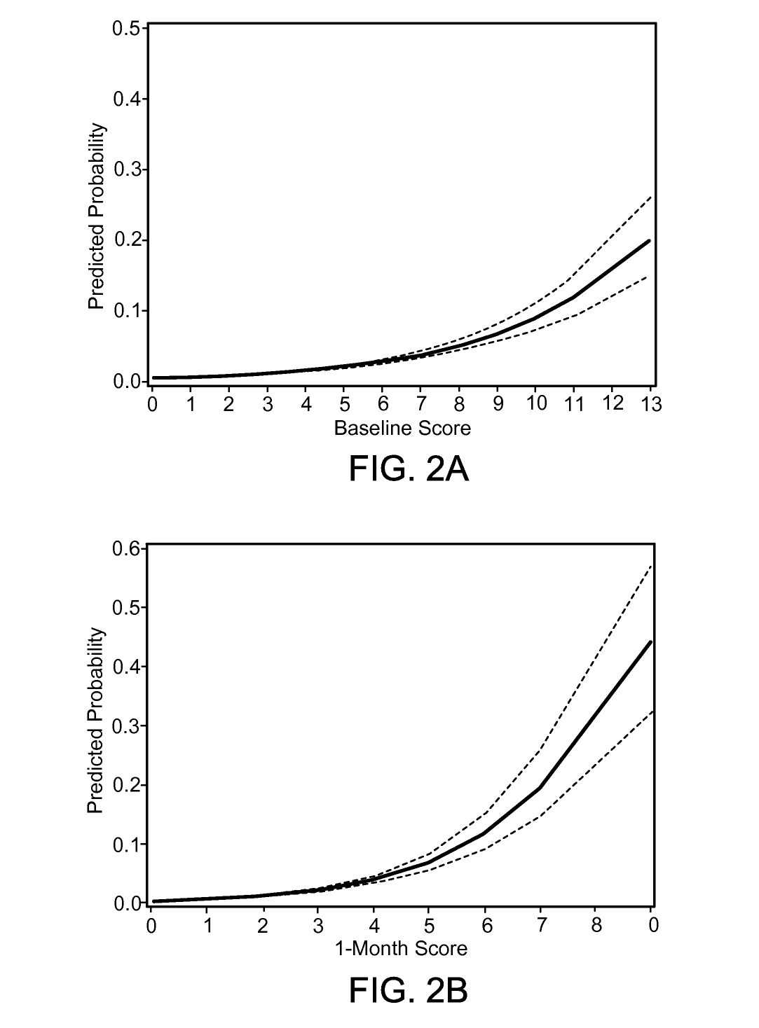

Since the data did not reflect the original sampling frame but instead consisted of an equal number of PJI cases and matched controls, the model was re-calibrated to the overall population by weighting all cases and controls by their respective inverse sampling proportions. Based on internal data, it was determined that the prevalence of PJI in TKA/THA subjects is about 1.8%. From this weighted regression, predicted probabilities for both the baseline and post-surgery risk scores were computed and plotted by corresponding risk score (FIG. 2).

### OTHER EMBODIMENTS

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. A method for detecting an arthroplasty patient as having a 20% or more chance of developing prosthetic joint infection, wherein said method comprises detecting the presence of 13 or more points for said patient, wherein:
(a) two points are assigned to said patient if said patient has a BMI ≧40 or <25;
(b) two points are assigned to said patient if said patient has had prior other surgery;
(c) two points are assigned to said patient if said patient has had prior arthroplasty;
(d) two points are assigned to said patient if said patient is immunosuppressed;
(e) two points are assigned to said patient if said patient has an ASA score of 3;
(f) six points are assigned to said patient if said patient has an ASA score of 4;
(g) one point is assigned to said patient if said patient had a procedure time of less than two hours; and
(h) three points are assigned to said patient if said patient had a procedure time of more than four hours.

2. A method for detecting an arthroplasty patient with a score of 13 or higher who has a 20% chance of developing prosthetic joint infection, wherein said method comprises:
(a) assigning a score of two points if said patient has a BMI ≧40 or <25;
(b) assigning a score of two points if said patient has had prior other surgery;
(c) assigning a score of two points if said patient has had prior arthroplasty;
(d) assigning a score of two points if said patient is immunosuppressed;
(e) assigning a score of two points if said patient has an ASA score of 3;
(f) assigning a score of six points if said patient has an ASA score of 4;
(g) assigning a score of one point if said patient had a procedure time of less than two hours; and
(h) assigning a score of three points if said patient had a procedure time of more than four hours.

3. A method for detecting an arthroplasty patient having at least a 17% chance of developing prosthetic joint infection, wherein said method comprises detecting, at least two weeks post procedure, the presence of 7 or more points for said patient, wherein:
(a) one point is assigned to said patient if said patient has a BMI ≧40 or <25;
(b) one point is assigned to said patient if said patient has had prior other surgery;
(c) one point is assigned to said patient if said patient has had prior arthroplasty;
(d) one point is assigned to said patient if said patient is immunosuppressed;
(e) one point is assigned to said patient if said patient has an ASA score of 3;
(f) three points are assigned to said patient if said patient has an ASA score of 4;
(g) one point is assigned to said patient if said patient had a procedure time of less than two hours;
(h) two points are assigned to said patient if said patient had a procedure time of more than four hours; and
(i) three points are assigned to said patient if said patient had wound drainage within one month of arthroplasty.

4. A method for detecting an arthroplasty patient at one month post procedure with a score of 7 or higher who has a 17% chance of developing prosthetic joint infection, wherein said method comprises:
(a) assigning a score of one point if said patient has a BMI ≧40 or <25;
(b) assigning a score of one point if said patient has had prior other surgery;
(c) assigning a score of one point if said patient has had prior arthroplasty;
(d) assigning a score of one point if said patient is immunosuppressed;
(e) assigning a score of one point if said patient has an ASA score of 3;
(f) assigning a score of three points if said patient has an ASA score of 4;
(g) assigning a score of one point if said patient had a procedure time of less than two hours;
(h) assigning a score of two points if said patient had a procedure time of more than four hours; and
(i) assigning a score of three points if said patient had wound drainage within one month of arthroplasty.
